(19) United States
(12) Patent Application Publication
(10) Pub. No.: US 2007/0000624 A1
(43) Pub. Date: Jan. 4, 2007

(54) Roller blind with electronic pinch protection

(75) Inventors: Melf Hansen, Gondelsheim (DE); Werner P. Schlecht, Aurich (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: BOS GmbH & Co. KG, Ostfildern (DE)

(21) Appl. No.: 11/401,052

(22) Filed: Apr. 10, 2006

(30) Foreign Application Priority Data
Jun. 30, 2005 (DE) 10 2005 030 962.3

(51) Int. Cl. B60J 1/20

(52) U.S. Cl. 160/370.22

(57) ABSTRACT

A window roller blind assembly for motor vehicles which includes a roller blind that can be drawn from a wind-up shaft by a motor driven driving element engageable with a pull rod of the roller blind. To prevent pinching as a result of the pull rod engaging an obstacle during operation of the roller blind assembly, an electrical system is provided for monitoring operation of the roller blind motor. The system is operable for switching off current to the motor when a preset value is exceed, which is interpreted as a signal that pinching or squeezing of an obstacle is occurring.

### FIELD OF THE INVENTION

This present invention relates generally to window shades, and more particularly, to power operated window shades for motor vehicles.

### BACKGROUND OF THE INVENTION

Electronically operated roller sunshades are increasingly being used in motor vehicles. These roller sunshades are used on the side windows of rear doors, the rear window, or the glass sunroof. A roller blind for rear windows, for example, is known from DE 103 51 040 A1. The rear window roller blind described therein comprises a winding shaft that is rotatably supported underneath the rear window shelf, with one edge of the roller blind shade fixed on the winding shaft. The free end of the roller blind material is connected to a pull or tension rod. The pull rod is tubular and accommodates the neck of two guide pieces, which are provided on each end of the rod. The guide pieces run in guide rails which are arranged in the interior panel beside the rear window. The pull rod is driven via linear thrust elements that run in the guide rails. The drive elements, on the other hand, are driven via an output gear of a geared motor. Roller blinds for motor vehicle side windows or for sunroofs basically have the same design.

Due to the electromotor drive mechanism, there is a certain risk of the pull rod pinching an obstacle during operation. The motor is somewhat over designed with respect to the drive power required. The turning off of the motor is time-controlled, as a rule, which means that when the shade is being extended and the pull rod runs against an obstacle, it will remain pressed there with considerable force until the motor is turned off by the time grid.

The operating force is comparatively high and there is a risk of injury if someone were to reach between the moving pull rod and a fixed buffer in the vehicle. Such danger exists in the course of both retraction and extension of the shade. The danger particularly exists for side windows when the side window is lowered. Similar conditions exist for an opened sunroof.

In rear windows wherein the window shade pull-out is operated via a lever arrangement, a danger of pinching also arises when the shade is retracted because the pull-out power is not passive via the spring motor of the winding shaft but is operated via the electromotor.

### OBJECTS AND SUMMARY OF THE INVENTION

It is an object of the invention to provide a roller blind for motor vehicles that is safe to operate and in which the risk of injury through pinching is reduced.

In the novel window roller blind, a rotatably supported winding shaft is provided with one edge of the roller blind material being fastened to the winding shaft. The edge away from the winding shaft is connected to a tension or pull rod arrangement. At least one electromotor is provided in order to move the roller blind in at least one direction. A sensor is associated with the electromotor in order to detect an operating parameter of the electromotor. Depending on the installation site and the overall arrangement, this operating parameter can be the current consumed by the motor, the change in current dI/dt of the motor current or the rpm of the motor, or the change in rpm dn/dt. These operating parameters change depending on whether the motor drives only the roller blind or whether, in addition, any objects are in the path of movement of the pull-out profile that would cause an obstruction. As a result, pinching as a result of such obstruction with the risk of injury can be avoided. At the same time, this arrangement facilitates a limit stop with minimal restraint in the system.

In carrying out the invention, a control circuit connected to the sensor evaluates the signal emitted by the sensor and ensures that, independently of further operation, the motor current is switched off when the limit value is exceeded. Through this measure, the force originating at the tension rod arrangement can be maintained within such limits that practically prevent injury.

Depending on how the shade is mechanically operated, i.e., whether the tension rod arrangement is operated with the electromotor in the sense of moving away from the pull-out slot or in the opposite direction, the limit value can be set for the operating parameter during extension or during retraction. If the movement of the tension rod arrangement in both directions takes place through the electromotor and there is a pinching hazard in both directions, it may be important to monitor the operating parameter in both directions. In rear window roller blinds widely distributed today, the rolling of the roller blind around the winding shaft takes place with the aid of a spring motor. In that case, it suffices to monitor only the current during the extension.

Other objects and advantages of the invention will become apparent upon reading the following detailed description and upon reference to the drawings, in which:

### BRIEF DESCRIPTION OF THE DRAWING(S)

FIG. 1 is a broken open perspective of a rear area of a motor vehicle having a roller window shade in accordance with the invention;

FIG. 2 is a schematic depiction of the window roller shade of the present invention shown in an extended position;

FIG. 3 is a circuit diagram of the motor circuit monitoring system for the illustrated roller blind;

FIG. 4 is a flow chart for the motor current monitoring system shown in FIG. 3;

FIG. 5 is a broken away perspective of the roof of a motor vehicle with a roof roller blind according to the invention; and

FIG. 6 is a perspective of a rear window roller blind with an alternative lever arrangement for moving the window shade pull rod.

While the invention is susceptible of various modifications and alternative constructions certain illustrative embodiments thereof have been shown in the drawings and will be described below in detail. It should be understood, however, that there is no intention to limit the invention to the specific forms disclosed, but on the contrary, the intention is to cover all modifications, alternative constructions, and equivalents falling within the spirit and scope of the invention.

### DETAILED DESCRIPTION OF THE INVENTION

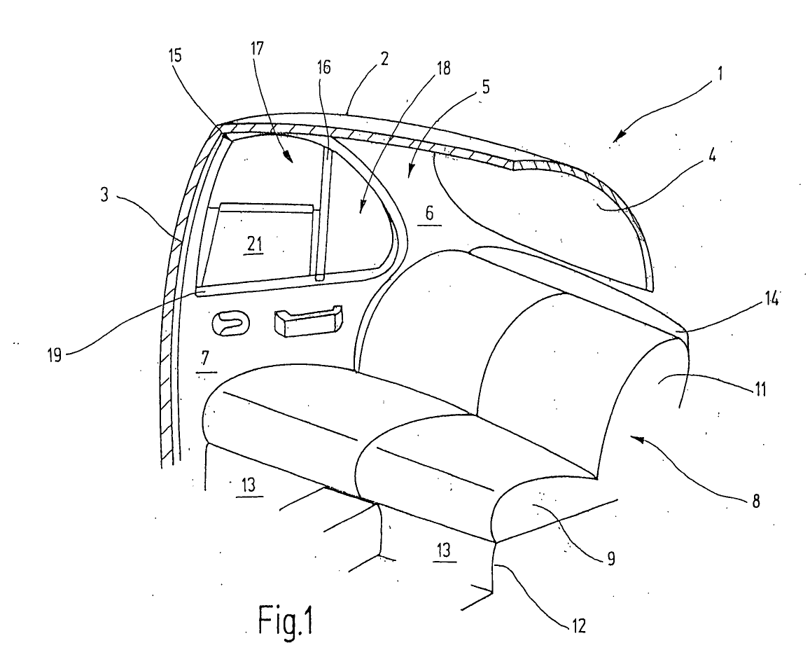

Referring now more particularly to FIG. 1 of the drawings, there is shown an illustrative motor vehicle having a side window roller blind assembly in accordance with the invention. FIG. 1 represents a cut-away rear area of a passenger car. The figure illustrates a view towards the right-side interior, which is the mirror image of the not-shown left-side interior. The view is simplified; for example, car body interior structures such as braces and attachment means are not shown because their illustration is not necessary for understanding the invention.

The illustrated car body section 1 has a roof 2 from which a B-column 3 extends downwardly at the side to a an underbody. A corresponding B-column is provided on the opposite side of the vehicle. The roof 2 transitions at its rear edge into a rear window 4. At the side, the rear window 4 ends at a C-column 5 located at a distance from the B-column 3. The C-column 5 carries an interior lining 6.

Between the B-column and the C-column, a rear right side door 7 is hinged in a known way to the B-column. At the height of the right rear side door 7 there is a rear seat bench 8 which includes a sitting surface 9 and also a rear seat back 11. The rear seat back 9 is supported on a base surface 12 that is part of the underbody in front of which are foot spaces 13. At the height of the top edge of the rear seat back 11, a rear seat shelf 14 extends to the bottom edge of the rear window 4.

The right rear side door 7 is provided with a side window 15 typical for sedans. The side window 15 is divided by a vertical brace 16 into essentially a four-cornered window panel 17 as well as a generally triangular configured window panel 18. The window panels are bordered by an apron or frame 19 having a rounded end that forms an angle less than 900. The window panel 17 is moveable upwardly and downwardly in a known manner, being guided in part by the vertical brace 16.

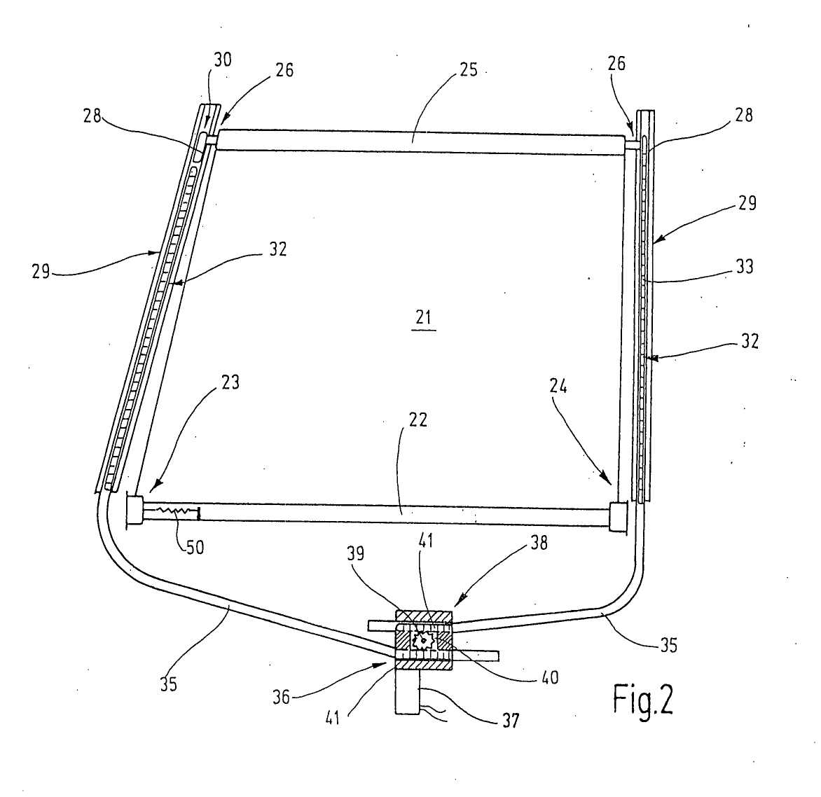

The window panel 17 in this case may be selectively shaded by a roller blind 21, which may be drawn out of the inner space of the door 7 through a groove in the apron 17. A drive mechanism for the roller blind 21, as depicted in FIG. 2 is disposed in the interior of the door below the apron 19.

The illustrated roller blind 21 has a section, which generally corresponds to the surface of the window panel 17 and has essentially straight edges. The roller blind 21 is fastened with its lower edge on a winding shaft 22, which is rotatably supported between winding shaft support arrangements 23, 24.

The edge of the roller blind 21 away from the winding shaft 22 forms a tubular loop 25, through which a pull rod or tension member passes, with only outer extending overhang or guide arms 26 thereof being seen in the drawings. The guide arms 26, which each have a respective guide 28 at its outer end, are telescopically movable relative to ends of the pull rod.

In order to guide the roller blind 21 during an extension movement, two guide rails 29 run laterally beside the drawn out roller blind 21. Each guide rail 29 has a slot chamber 30 running in the longitudinal direction, which is generally circular in cross sections and opens toward the roller blind 21 via a notch slot 31.

In both slot chambers 30 of the two guide rails 29 run axially movable thrust elements 32. Each thrust element 32 consists of a cylindrical core 33, around which a raised helix 34 is provided. The helix 34 forms a tooth running helically around the core 33. The thrust element 32 consequently has the shape of a flexible toothed rack with circular cross section. The thrust elements 32 themselves are not buckle-resistant, and hence, are guided in the slot chamber 30 in such a way as to avoid bending.

At the lower end of each guide rail 29, guide tubes 35 connect the guide rails 29 to a drive motor 36. The drive motor may be a dc motor having a gear box 38. An output shaft 39 has a gear 40 designed to the drive thrust elements 32 in a known manner as the thrust elements tangently pass the gear 40 and are retained in buckle-resistant fashion. In order to prevent the thrust elements 32 from tilting from side to side, they are guided in boreholes 41 that run tangentially past the output gear 40. The guide tubes 35 fit into these boreholes 41. There also is room in the extension of the boreholes 41 for storing that guide the non-active part of the thrust elements.

The mode of operation of the window shade is as follows:

In the retracted state of the roller blind, the pull rod 25 is directly adjacent to the winding shaft 22 in a withdrawn condition underneath the side rail 19 of the side window 17. If the user, starting from this position, wants to extend the roller blind 21 in front of the window 17, he starts the geared motor 36. As a result, the two thrust elements 32 are synchronously fed into the appropriate guide rails 29. During the process, they press the guides 28 upwardly on both sides of the roller blind 21. The spring drive 42 acts against this feed motion, as schematically indicated in FIG. 2, with the force of the spring motor 42 constantly striving to roll the roller blind 21 onto the winding shaft 22.

To retract the roller blind 21, the geared motor 37 is operated in the reverse direction of rotation. As a result, the thrust elements 32 are drawn downwardly from the guide rails 29 toward the winding shaft 22, and in the process, permit the pull rod 25 to move downwardly, with the spring motor 42 contained in the winding shaft 22 rolling the roller blind 21 onto the winding shaft 22. The retraction is ended when the loop of the shade about the pull rod 25 arrives at the groove.

While not apparent from the foregoing, a pinching hazard can exist when extending the side roller blinds. If, for instance, the side window is opened and the gear motor is started in the direction of extending the roller blind 21, something can get caught between the rigid pull rod 25 and the upper edge of the window. The power supplied by the geared motor 36 can be so high that catching between the upper edge of the window and the tension rod arrangement 25 may result in injury.

In accordance with the invention, in order to prevent such safety hazard, an electronic pinch protection circuit 45 is provided. The pinch protection circuit 45 in one embodiment includes a current sensing resistor 46 connected in series with the DC motor 37 and the break contact 47 of a relay 48. The break contact 47 is electrically connected to the vehicle electrical system 49 via a connecting line 51. Another connecting line 52 connects the other end of the DC motor 37 also to the vehicle electrical system 49, which is shown here only schematically. In practice, the pinch protection will involve the central control of the motor vehicle, with whose help control is executed via a switch, so that normally the drive motor 37 can be started for the side window shade optionally in a particular operating direction. Details of the arrangement within the electrical system 49 are not the subject of the invention.

To detect the current consumed by the DC motor 37, a microprocessor or microcontroller 53 is provided, with its inputs 54 and 55 on either side of the current sense resistor 46. Another input 56 is connected to the connecting line 52, while an input 57 of the microprocessor leads to the connection line 51. The magnetic coil of the relay 48 is connected to the microprocessor 53 via two outputs 58 and 59.

For as long as the break contact 47 is closed, the roller blind arrangement works in the usual manner as described above. Depending on the direction of rotation of the DC motor 37, either the line 51 is grounded while the other line 52 carries the full battery voltage, or, during reverse rotation, the line 52 is grounded while the full battery voltage appears on line 51. The DC motor 37 is switched off when both lines 51 and 52 are at ground potential or at battery voltage potential. The microprocessor 53 evaluates this situation via its signal inputs 56 and 57.

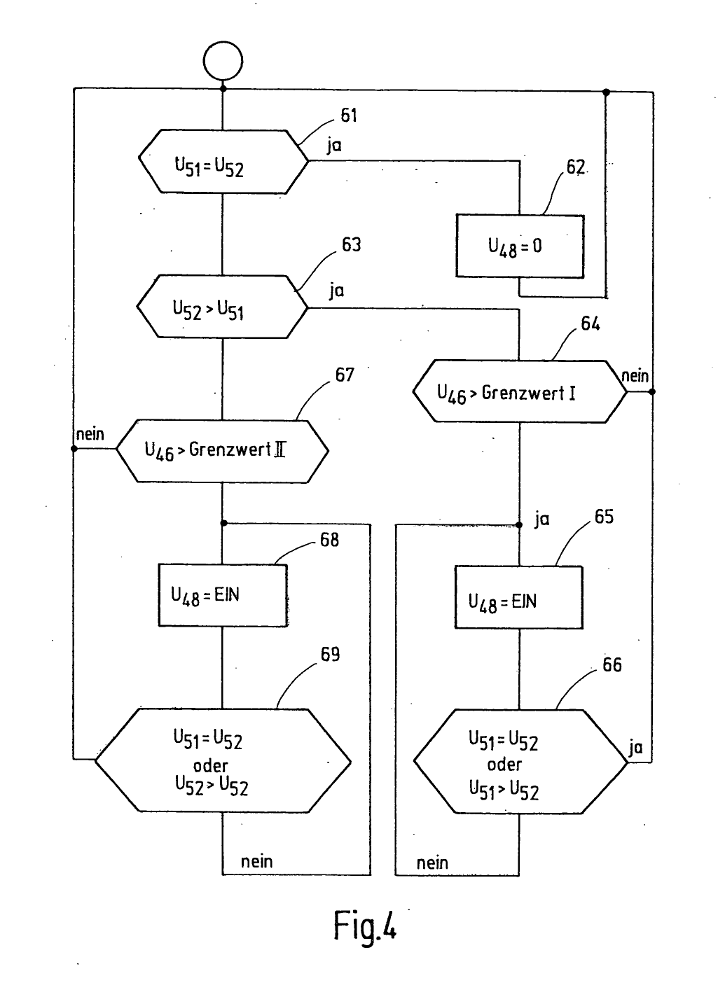

The pinch protection 49 operates in accordance with the flow chart of FIG. 4. If, according to the check of the decision block 61, the voltage on the line 51 is the same as the voltage on line 52, the current to the relay 48 is switched off and the break contact 47 is thus closed (process block 62). If the two voltages are not the same, if, for instance, there is an operation in the direction of extending the shade, if the voltage on line 52 is greater than the voltage on line 51, which is examined in decision block 63, the check in the decision block 64 is used and the microprocessor 53 examines the voltage drop across the resistance 46. As long as this voltage stays below a predetermined value, it is concluded that the tension rod arrangement 26 does not run against a resistance and a pinching hazard consequently does not exist. The program returns to the start and cyclically goes through the checks. If the tension rod arrangement 25 runs against a significant resistance in the course of the operation, the voltage drop across the sense resistance 46 rises above the limit value I. In this case, the decision block 64 is exited and program control goes to process block 65. Here, the current to the relay 48 is switched on, as a result of which the break contact 47 opens and the current to the motor 37 is interrupted.

In the subsequent decision block 66, the microprocessor 53 checks whether the voltage on line 51 was the same as the voltage on line 52, which indicates that the user had switched off the roller blind, or whether the voltages on lines 51 and 52 have reversed their previous polarities, which indicates that the user wants to operate the roller blind in the direction of retraction. If one of the two conditions is met, program control returns to the start, otherwise it goes to process block 65. As a result, the current to the motor 37 remains until it is switched off via the electrical pinch protection circuit 45, or when the user voluntarily switches off the roller blind or starts it in the opening direction.

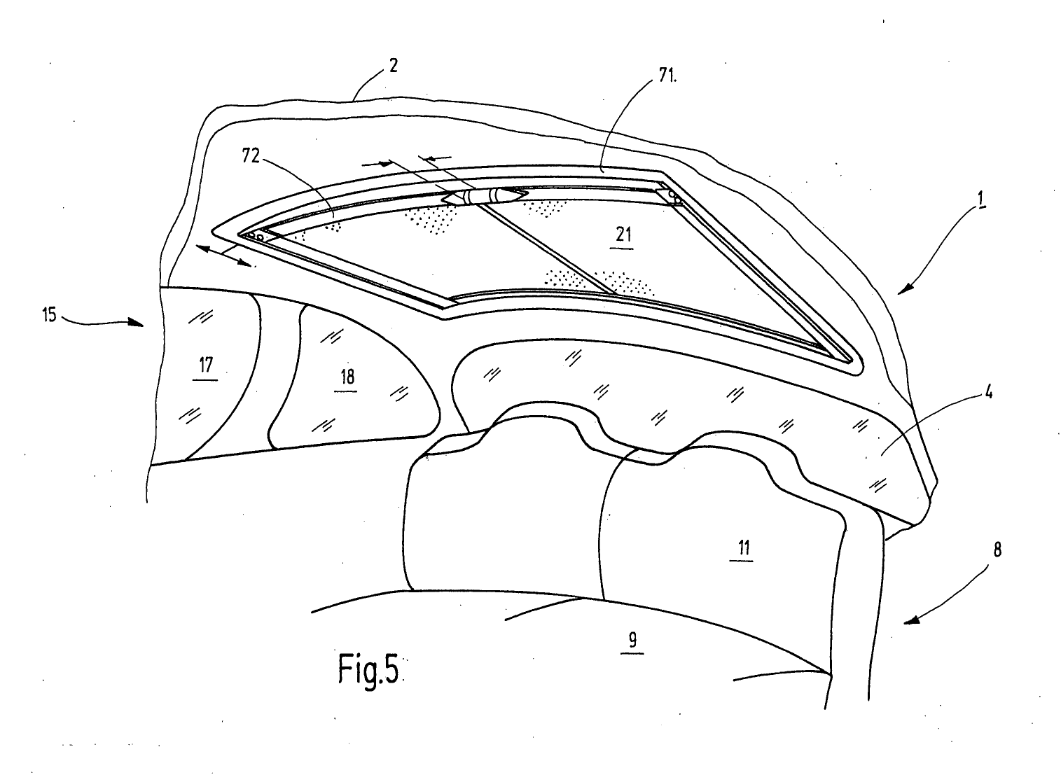

The pinch protection switch shown is suitable not just for side roller blinds, as explained with the aid of FIGS. 1 and 2, but also for sunroof roller blinds, as shown in FIG. 5, or for rear roller blinds, insofar as the operation of the tension rod arrangement 25 corresponds to the illustration in FIG. 2.

The mechanism and basic construction of a roller blind shown in FIG. 2 may be used for a rear roller blind. Such use is known from the prior art, for example from DE 100 57 760 A1, to which express reference is made. With a rear roller blind, there is a pinching hazard in both moving directions. During the course of extension, there is a pinching hazard between the roof lining and the tension rod arrangement 25. By way of example, certain mandatory standards assume that there is a pinching hazard when the gap is smaller than 200 nm.

There may also be a pinching hazard during the course of retraction. The tension rod arrangement 25 with the guide arms 26 laterally projecting over the roller blind 19 appears through the groove in the rear shelf. With such a configuration, the slot edges can function like scissors together with the guide arms 26 laterally projecting over the roller blind 19. A controlled switching off of the motor current in both moving directions is therefore recommended. Of course, the forces to be applied by the motor are inherently different and, depend on the moving direction. During the course of extension, the geared motor must work against the effect of the spring motor 42 and also overcome the frictional resistance of the thrust elements 32 in the guide tubes or guide rails 29. During the course of retraction, the conditions reverse insofar as the spring motor 42 operates in a supporting capacity. Moreover, the thrust elements 32 are loaded by traction and not by pressure and can in the process definitely generate other coefficients of friction in the guide tubes 29. Finally, in addition, during retraction, there is a pinching hazard in the lower movement region, specifically when the thrust elements 32 are withdrawn extensively from the guide rails 29 and the thrust elements 32 are largely under zero force in the storage tubes. It therefore makes sense to work with two different limit values, that are a function of the moving direction.

In this case, the basic flow chart of FIG. 4 is expanded by a decision block 67, in which it is checked whether the motor 37 uses more current in the reverse direction of rotation than allowable as per a limit value II. If yes, a process block 68 is started, which leads to opening of the break contact 47. This process block 68 is in turn executed until the direction reverses or the motor is switched off, which is checked in a process block 69.

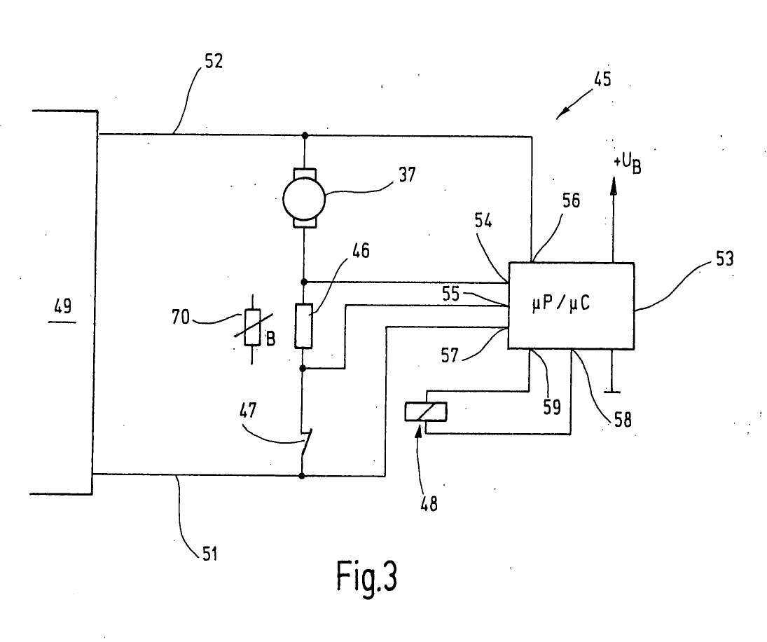

In FIG. 3, the instantaneous value of the motor current that is monitored by the current sensor 46 corresponds to the torque delivered by the motor. Instead of the instantaneous value of the motor current, the change in current dI/dt, i.e., the derivative of the motor current with respect to time can be used. The program of FIG. 4 consequently remains substantially unchanged, with the exception that instead of the instantaneous value U₄₆, the derivative of the voltage dU₄₆/dt is used. For this purpose, a differentiating circuit may be placed between current sensor 46 and the microprocessor. Alternatively, the current differentiation can be implemented in software in the microprocessor 53.

Instead of monitoring the motor current as a characterizing parameter for a pinching situation, the rotational speed (rpm) of the motor may be used as an indicator of the load condition. For this purpose, the electromotor 37 contains one or more Hall probes 70, as indicated by the broken lines in FIG. 3 by way of example. In this case, the flow chart of FIG. 3 is modified in that the rpm n is used in place of U₄₆. In the event that the rpm is used, it is also possible to use the change in rpm, dn/dt, as a criterion instead of the instantaneous rpm value, as the parameter.

Finally, it may be advantageous to use a combination of the above-mentioned monitoring of operating parameters, i.e., for example, the current and the rpm, or the change in current and the rpm, etc.

It will be appreciated that pinching hazards also exist in sunroofs and sunroof roller blinds. FIG. 5 shows a somewhat different shaped car body, wherein items similar to those described above have been given similar reference numerals. The motor vehicle in this case has a roof 2 with a rectangular roof section 71 within which a sunroof window is mounted.

Beneath the roof section 71 is a roller blind 21, whose free edge is attached to a pull rod 72 that corresponds to the tension rod 25 in FIG. 2 and is operated via a similar mechanism. A winding shaft in this case is in the region of the edge of the roof section 71 at the rear of the vehicle, while guide rails run parallel to the side edges. The potential hazard of pinching during operation of the window shade again can be eliminated by a drive similar to that described in connection with the previous embodiment.

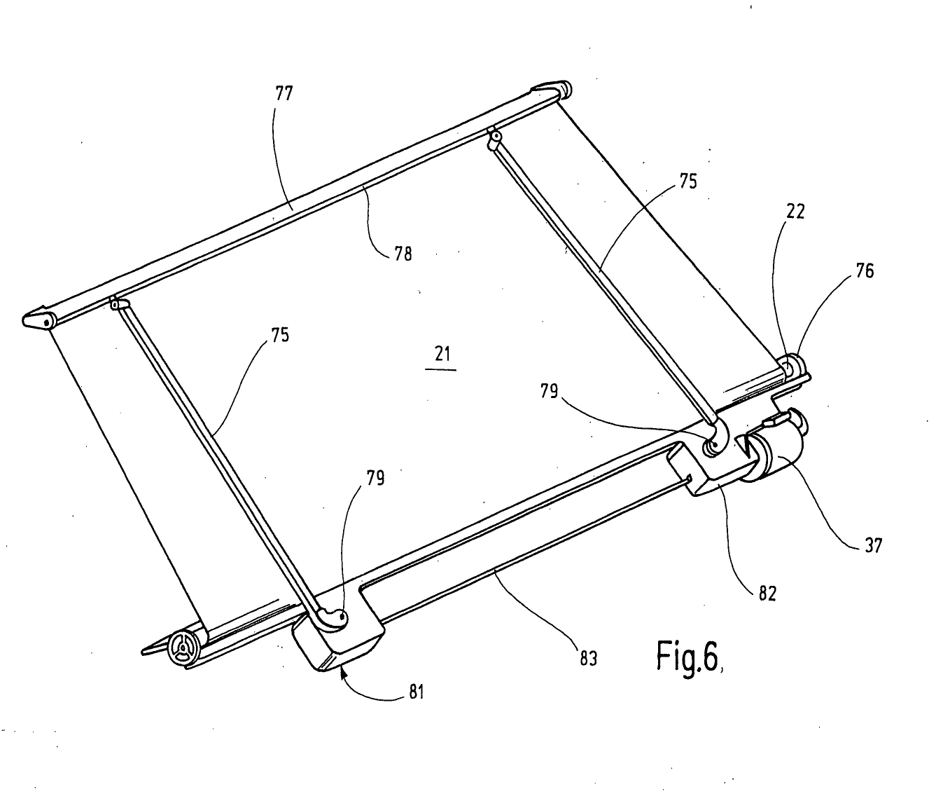

FIG. 6 shows still another rear roller blind in which the roller blind is operated via two one-armed levers 75. The aforementioned winding shaft 22 is rotatably mounted in an elongated tubular housing 76. As in the previous embodiments, it is biased via a spring motor in the direction of rolling up the roller blind 21. A pull-out element 77, whose function largely corresponds to the tension rod 25, is at the free edge of the roller blind 21, i.e., the edge away from the winding shaft. On the side turned toward the observer, it has grooves 78 that extend over the entire length of the pull-out element, within which free ends of the two levers 75 slide.

The levers 75 are fastened at their lower end to a respective output shaft 79. The output shaft 79 is part of an angular gear, which is accommodated in a housing 81 or 82. The housings 81, 82 are, as shown, at a distance from one another in the longitudinal direction of the housing 76. The output shafts 79 of the levers 75 extend parallel to one another. The lever arrangement is driven, for example, in rotary motion, by a DC motor 37 and/or the worm gear contained in a gear housing 82. The motor 37 is also connected via a coupling shaft 83 to the gear contained in the gear housing 81.

When the rear roller blind is in an extended position, as depicted in FIG. 6, the levers 75 are at approximately right angles to the longitudinal axis of the roller shaft 22. To retract the roller blind, the drive motor 37 is set in the appropriate rotary motion. This causes both levers 75 to pivot about each other, as a result of which the distance between their free ends and the roller shaft 22 decreases accordingly. The spring motor coupled to the roller shaft 22 ensures that the roller blind 21 remains stretched in every position of the levers 75. The retraction position of the roller blind is achieved when the two levers 75 extend roughly parallel to the winding shaft 22.

In a practical embodiment, the roller housing 76 is beneath the rear shelf 14 of the motor vehicle, with the roller blind being extendable through a slot contained in the rear shelf 14. In the extended position, the levers 75 are generally parallel to the interior of the rear window 4.

It can be seen that a pinching hazard can exist in the completely extended position between the upper edge of the window or the roof, on the one hand, and the pull-out element 77, on the other, as well as when the pull-out element 77 hits the slot edges.

In the extended position of the roller blind, because the levers 75 stay upright, relatively great pinching forces could be generated for a relatively small motor torque. On the other hand, in a retracted state, the pinching forces are less because the levers are in a lying down position. In order to take that into account, two limit values I and II are correspondingly set differently.

From the foregoing, it can be seen that window roller blinds for motor vehicles as provided that prevents pinch hazards during operation of the roller blind. To that end, one or more operating parameters of the electromotor that moves the roller blade is monitored. The motor current can be switched off when a predetermined limit value is exceeded, which is interpreted as a signal that potentially hazardous pinching or squeezing situation is occurring.

1. A roller blind assembly for motor vehicles comprising:
a winding shaft (22) supported for rotational movement,
a roller blind (21) having one edge fastened to said winding shaft (22) and another edge for movement away from the winding shaft (22);
a pull rod (25,77) affixed to said other roller blind edge;
a selectively operable electromotor (37) for moving a roller blind 21 in at least one direction,
a sensor (46) for detecting an operating parameter of the electric motor (37); and
a control switch (45) having an input (54,55) at said one sensor (46) and a control program that monitors the operating parameter of the electromotor (37) and upon exceeding at least one specified limit value (I, II) switches off the current to the electromotor (37).

2. The roller blind assembly of claim 1, wherein the operating parameter is a current consumed by the electromotor (37), a rate of change in the current, an rpm of the electromotor (37), or a rate of change of the rpm.

3. The roller blind assembly of claim 1, wherein the sensor (46) is a current sensor for sensing a current consumed by the electromotor (37).

4. The roller blind assembly of claim 1, wherein the current sensor is a linear ohmic resistor.

5. The roller blind assembly of claim 1, wherein the sensor (46) is an rpm sensor (70).

6. The roller blind assembly of claim 1, wherein the sensor (46, 70) is at least one Hall probe.

7. The roller blind assembly of claim 1, wherein the limit value (I, II) is applied to the operating parameter of the electromotor (37) when the roller blind (21) is being extended.

8. The roller blind assembly of claim 1, wherein the limit value (I, II) is applied to the operating parameter of the electromotor (37) when the roller blind (21) is being retracted.

9. The roller blind assembly of claim 1, wherein the control program uses first and second control two limit values (I, II), the first limit value (I) being applied when the roller blind (21) is being extended, and the second limit value (II) being applied when the roller blind (21 ) is being retracted.

10. The roller blind assembly of claim 9, wherein the first and second limit values (I, II) are different in magnitude and/or polarity.

11. The roller blind assembly of claim 1 including a spring motor (42) prebiased for rotating said wind-up shaft in a direction for rolling up the roller blind (21).

12. The roller blind assembly of claim 1 in which said winding shaft is coupled to said electromotor (37).

13. The roller blind assembly of claim 1 including guide rails (29) for guiding movement of said tension rod.

14. The roller blind assembly of claim 13 in which said guide rails define a guide groove chamber (30) and a relatively narrow width guide slot (31).

15. The roller blind assembly of claim 14 in which said drive includes linear thrust elements (32) disposed within the groove chambers (30) of said guide rails which are coupled to and driven by said electromotor (37).

16. The roller blind assembly of claim 1 in which said tension rod is coupled to a lever arrangement (75) which is operable for effecting movement of said tension rod between extended and retracted positions.

17. The roller blind assembly of claim 16 in which said lever arrangement is connected to and operated by said electromotor (37).
